(19) United States
(12) Patent Application Publication
(10) Pub. No.: US 2019/0287531 A1
(43) Pub. Date: Sep. 19, 2019

(54) SHARED TERMINAL, INFORMATION PROCESSING SYSTEM, AND DISPLAY CONTROLLING METHOD

(71) Applicant: RICOH COMPANY, LTD., TOKYO (JP)

(72) Inventor: Keisuke Tsukada, Kanagawa (JP)

(73) Assignee: RICOH COMPANY, LTD., TOKYO (JP)

(21) Appl. No.: 16/269,611

(22) Filed: Feb. 7, 2019

(30) Foreign Application Priority Data
Mar. 19, 2018 (JP) 2018-051276

(51) Int. Cl. G10L 15/26; H04L 29/08; G10L 15/22; G09G 5/00

(52) U.S. Cl. CPC G10L 15/265; G09G 5/003; G10L 15/22; H04L 67/10

(57) ABSTRACT

A shared terminal includes processing circuitry. The processing circuitry acquires sound collected by a sound collecting device as audio data, displays a first indicator on a display, acquires text data generated based on the audio data, and displays the text data on the display together with the first indicator. The first indicator includes information of volume of the sound generated based on the audio data and information of speed of the sound calculated based on the audio data.

### CROSS-REFERENCE TO RELATED APPLICATION

This patent application is based on and claims priority pursuant to 35 U.S.C. § 119(a) to Japanese Patent Application No. 2018-051276 filed on Mar. 19, 2018, in the Japan Patent Office, the entire disclosure of which is hereby incorporated by reference herein.

### BACKGROUND

### Technical Field

The present invention relates to a shared terminal, an information processing system, and a display controlling method.

### Description of the Related Art

According to an existing technique, an electronic whiteboard and a sound recognizing apparatus are operated in cooperation with each other to operate the electronic whiteboard by sound, or convert audio data of sounds collected by the electronic whiteboard into text data and hold the converted text data.

As an example of such a technique, sounds of conversation input by an audio input device may be recognized and converted into text data, and a keyword meeting a predetermined condition may be extracted from the text data to retrieve and display an image according to the extracted keyword, for example.

According to the existing technique, however, there are some cases in which a speech of a user of the electronic whiteboard is different from the text data converted from the audio data of the collected sounds, for example

### SUMMARY

In one embodiment of this invention, there is provided an improved shared terminal that includes, for example, processing circuitry. The processing circuitry acquires sound collected by a sound collecting device as audio data, displays a first indicator on a display, acquires text data generated based on the audio data, and displays the text data on the display together with the first indicator. The first indicator includes information of volume of the sound generated based on the audio data and information of speed of the sound calculated based on the audio data.

In one embodiment of this invention, there is provided an improved information processing system that includes, for example, a shared terminal, an information processing apparatus, and processing circuitry. The information processing apparatus communicates with the shared terminal. The processing circuitry acquires sound collected by a sound collecting device as audio data, displays a first indicator on a display, acquires text data generated based on the audio data, and displays the text data on the display together with the first indicator. The first indicator includes information of volume of the sound generated based on the audio data and information of speed of the sound calculated based on the audio data.

In one embodiment of this invention, there is provided an improved display controlling method that includes, for example, acquiring sound collected by a sound collecting device as audio data, displaying a first indicator on a display, acquiring text data generated based on the audio data, and displaying the text data on the display together with the first indicator. The first indicator includes information of volume of the sound generated based on the audio data and information of speed of the sound calculated based on the audio data.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of display of an electronic whiteboard according to a first embodiment of the present invention;

FIG. 2 is a diagram illustrating an example of an information processing system according to the first embodiment;

FIG. 3 is a diagram illustrating an example of the hardware configuration of the electronic whiteboard according to the first embodiment;

FIG. 4 is a diagram illustrating an example of the hardware configuration of a smart speaker according to the first embodiment;

FIG. 5 is a diagram illustrating an example of the hardware configuration of a server according to the first embodiment;

FIG. 6 is a diagram illustrating functions of the electronic whiteboard and the server included in the information processing system according to the first embodiment;

FIG. 7 is a diagram illustrating an example of an optimal value table according to the first embodiment;

FIG. 8 is a flowchart illustrating an operation of the electronic whiteboard according to the first embodiment;

FIG. 9 is a diagram illustrating processes performed by the electronic whiteboard according to the first embodiment;

FIG. 10 is a diagram illustrating another example of display of the electronic whiteboard according to the first embodiment;

FIG. 11 is a diagram illustrating an example of display of an electronic whiteboard according to a second embodiment of the present invention;

FIG. 12 is a diagram illustrating functions of the electronic whiteboard and the server included in an information processing system according to the second embodiment;

FIG. 13 is a diagram illustrating an example of a threshold table according to the second embodiment;

FIG. 14 is a flowchart illustrating an operation of the electronic whiteboard according to the second embodiment;

FIG. 15 is a diagram illustrating another example of display of the electronic whiteboard according to the second embodiment;

FIG. 16 is a diagram illustrating functions of an electronic whiteboard and a server included in an information processing system according to a third embodiment of the present invention;

FIG. 17 is a sequence diagram illustrating an operation of the information processing system according to the third embodiment; and

FIG. 18 is a diagram illustrating an information processing system according to a fourth embodiment of the present invention.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

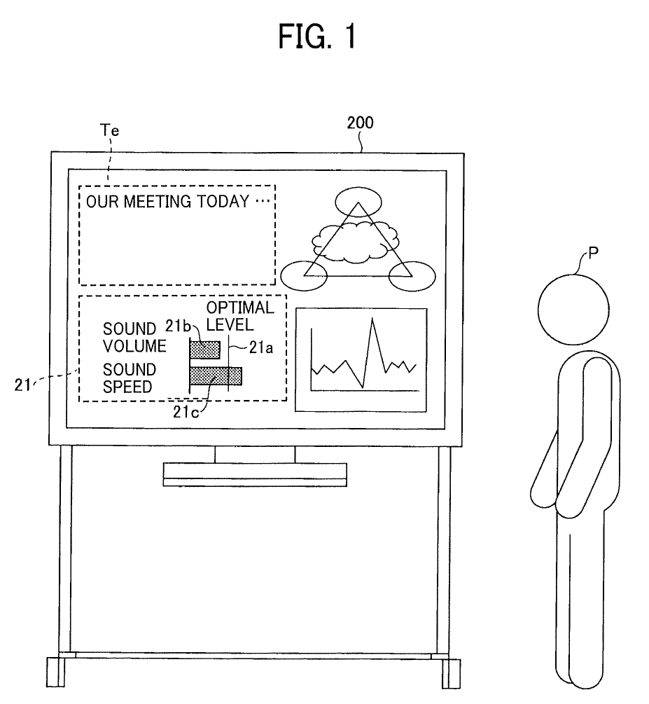

A first embodiment of the present invention will be described below with FIGS. 1 to 10.

FIG. 1 is a diagram illustrating an example of display of an electronic whiteboard according to the first embodiment. When audio data (e.g., speech data) is converted into text data, the degree of match between the audio data and the text data largely depends on the input environment of the audio data.

In view of this, an electronic whiteboard 200 of the first embodiment displays an indicator of speech when the audio data is acquired. As well as the indicator of speech, the electronic whiteboard 200 of the first embodiment also displays text data generated based on the audio data.

Major components of the input environment of the audio data include the distance between a person who speaks (i.e., speaker) and a sound collecting device such as a microphone and the speaking speed of the speaker. In addition to the distance and the speaking speed, the input environment of the audio data may include a component such as the direction in which the speaker faces while speaking.

In the first embodiment, the indicator of speech of the speaker refers to information of a result of comparing the sound volume and the speaking speed obtained from the input audio data with an optimal sound volume and an optimal speaking speed, respectively, which are set as optimal values for converting the audio data into the text data.

The electronic whiteboard 200 illustrated in FIG. 1 displays, on a display thereof, an indicator 21 of speech of a speaker P and text data Te generated based on the input audio data. A method of acquiring the text data Te will be described in detail later.

In the example of FIG. 1, information of a result of comparing the sound volume and the sound speed obtained from the input audio data with the respective optimal values of the sound volume and the sound speed is displayed as the indicator 21. That is, in the example of FIG. 1, the electronic whiteboard 200 displays, as the indicator 21, information of a result of comparing the loudness (i.e., sound volume) of the voice of the speaker P and the speaking speed (i.e., sound speed) of the speaker P with the respective optimal values of the sound volume and the sound speed.

The optimal values of the first embodiment include the respective values of the sound volume and the sound speed of the audio data considered to be most desirable for converting the audio data into the text data. The optimal values of the first embodiment may be previously set in the electronic whiteboard 200. Details of the optimal values will be described later.

The electronic whiteboard 200 of the first embodiment may display the indicator 21 when the audio data starts to be input after the speaker P starts speaking, for example.

As the indicator 21, the electronic whiteboard 200 displays a fixed line 21a corresponding to the respective optimal values of the sound volume and the sound speed, a graph 21b representing the sound volume generated from the input audio data, and a graph 21c representing the sound speed calculated from the input audio data. The electronic whiteboard 200 changes the length of each of the graphs 21b and 21c in accordance with the result of comparing the sound volume or the sound speed with the corresponding optimal value.

In the first embodiment, the indicator 21 is thus displayed to inform the speaker P whether the loudness (i.e., sound volume) of the voice of the speaker P and the speaking speed (i.e., sound speed) of the speaker P are close to the respective optimal values of the sound volume and the sound speed. That is, in the first embodiment, the indicator 21 of speech of the speaker P and the text data Te converted from the audio data are displayed to let the speaker P know whether the audio data of the speech of the speaker P has a sound volume and a sound speed suitable for converting the audio data into the text data.

According to the first embodiment, therefore, it is possible to prompt the speaker P to adjust the distance between the speaker P and the electronic whiteboard 200 and/or the speaking speed of the speaker P by checking the indicator 21, and thus to improve the accuracy of conversion from the audio data into the text data. That is, the first embodiment provides the indicator 21 of speech to the speaker P.

The display position of the indicator 21 may be any position on the display of the electronic whiteboard 200, and may be set by the speaker P.

The electronic whiteboard 200 of the first embodiment will be described in more detail below.

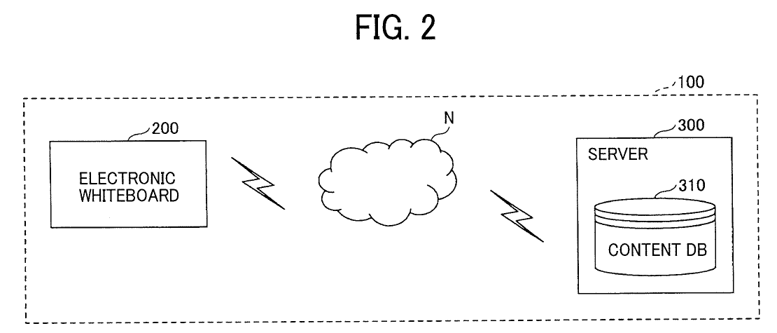

FIG. 2 is a diagram illustrating an example of an information processing system according to the first embodiment. The electronic whiteboard 200 of the first embodiment is included in an information processing system 100. The information processing system 100 of the first embodiment includes the electronic whiteboard 200 and a server 300, which communicate with each other via a network N.

In the information processing system 100 of the first embodiment, the electronic whiteboard 200 transmits information such as stroke information and image data to the server 300. For example, the stroke information represents a handwritten input letter or image, and the image data is data of an image capturing a screen on the electronic whiteboard 200. The electronic whiteboard 200 of the first embodiment includes a sound collecting device such as a microphone, and transmits audio data of sounds collected by the sound collecting device to the server 300.

The audio data of the first embodiment is digitized data of a waveform representing all sounds collected by the sound collecting device. In the first embodiment, therefore, speech data of the voice of a person speaking near the electronic whiteboard 200 is a part of the audio data.

For example, the electronic whiteboard 200 of the first embodiment may detect the speech data of speech of a person in the audio data of the sounds collected by the sound collecting device, and may display the indicator 21 when the speech data is input.

The server 300 of the first embodiment stores the received stroke information, image data, and audio data in a content database (DB) 310. The server 300 of the first embodiment further stores the text data converted from the audio data such that the text data and the audio data are associated with each other.

For example, when the electronic whiteboard 200 is used in a meeting, the server 300 may store the name of the meeting, the stroke information, image data, and audio data acquired during the meeting, and the text data converted from the audio data such that these information or data items are associated with each other. That is, the server 300 may store, for each meeting, a variety of information acquired from the electronic whiteboard 200. In the following description, the variety of data transmitted to the server 300 from the electronic whiteboard 200 will be referred to as the content data. The content data of the first embodiment therefore includes the audio data, the image data (e.g., video data), and the stroke information, for example.

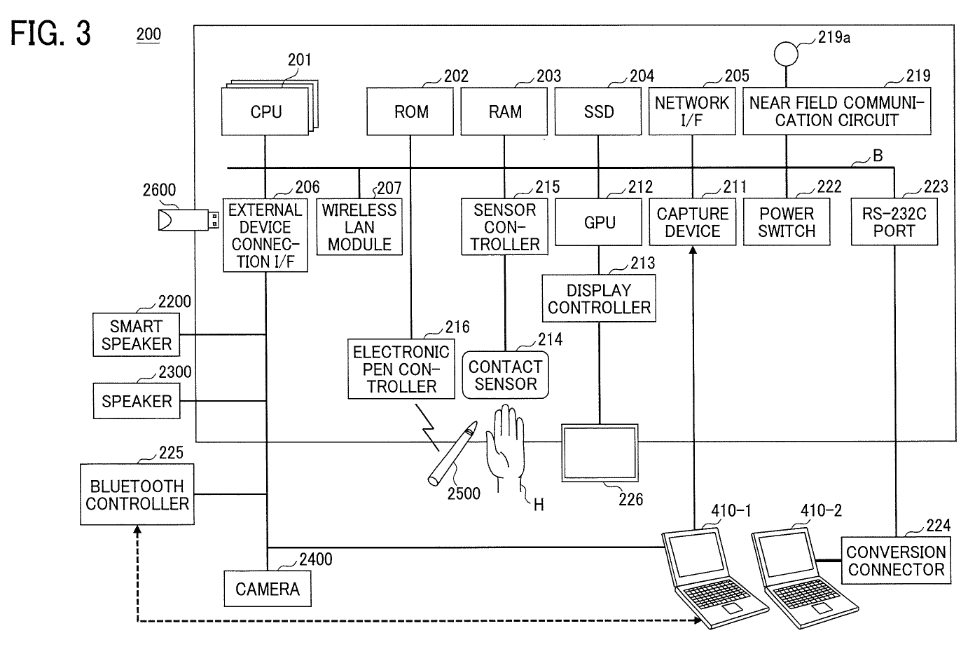

A hardware configuration of the electronic whiteboard 200 of the first embodiment will now be described with FIG. 3.

FIG. 3 is a diagram illustrating an example of the hardware configuration of the electronic whiteboard 200 of the first embodiment. As illustrated in FIG. 3, the electronic whiteboard 200 is a shared terminal including a central processing unit (CPU) 201, a read-only memory (ROM) 202, a random access memory (RAM) 203, a solid state drive (SSD) 204, a network interface (I/F) 205, an external device connection I/F 206, and a wireless local area network (LAN) module 207. The shared terminal is an electronic apparatus sharable by a plurality of people, and may be an electronic apparatus other than the electronic whiteboard 200.

The CPU 201 controls an overall operation of the electronic whiteboard 200. The CPU 201 may include a plurality of CPUs, for example.

The ROM 202 stores a program used to drive the CPU 201, such as an initial program loader (IPL). The RAM 203 is used as a work area for the CPU 201. The SSD 204 stores a variety of data such as programs for the electronic whiteboard 200. The network IN 205 controls communication with a communication network. The external device connection I/F 206 controls communication with a universal serial bus (USB) memory 2600 and external devices such as a camera 2400, a speaker 2300, and a smart speaker 2200. The wireless LAN module 207 connects the electronic whiteboard 200 to a network via a wireless LAN.

The electronic whiteboard 200 further includes a capture device 211, a graphics processing unit (GPU) 212, a display controller 213, a contact sensor 214, a sensor controller 215, an electronic pen controller 216, a near field communication circuit 219 including an antenna 219a, and a power switch 222.

The capture device 211 displays visual information on a display of a personal computer (PC) 410-1 as a still or video image. The GPU 212 is a semiconductor chip specifically for graphics processing. The display controller 213 controls and manages screen display to output an input image from the GPU 212 to a display 226, for example. The contact sensor 214 detects contact of an electronic pen 2500 or a hand H of a user on the display 226.

The sensor controller 215 controls the processing of the contact sensor 214. The contact sensor 214 performs input and detection of coordinates according to an infrared blocking method. In this method of inputting and detecting coordinates, two light receiving devices installed to opposite end portions of an upper area of the display 226 radiate a plurality of infrared rays parallel to the display 226, and receive rays of light reflected by a reflecting member installed around the display 226 and returning on optical paths of the rays radiated by the two light receiving devices. The contact sensor 214 outputs, to the sensor controller 215, identifications (IDs) of the infrared rays radiated by the two light receiving devices and blocked by an object. Then, the sensor controller 215 identifies the position of the coordinates, which corresponds to the position of contact of the object on the display 226.

The electronic pen controller 216 communicates with the electronic pen 2500 to determine contact or non-contact of the head or end of the electronic pen 2500 on the display 226. The near field communication circuit 219 is a communication circuit using a technology such as near field communication (NFC) or Bluetooth (registered trademark).

The power switch 222 is a switch for switching on or off a power supply of the electronic whiteboard 200.

The electronic whiteboard 200 further includes a bus line B, which includes address buses and data buses to electrically connect the CPU 201 and the other component elements illustrated in FIG. 3 to each other.

The electronic whiteboard 200 further includes a recommended standard (RS)-232C port 223, a conversion connector 224, and a Bluetooth controller 225.

The RS-232C port 223 is connected to the bus line B to connect the CPU 201 to a PC 410-2, for example. The conversion connector 224 is a connector for connecting the electronic whiteboard 200 to a USB port of the PC 410-2. The Bluetooth controller 225 is a controller for communicating with the PC 410-1, for example, by using Bluetooth technology.

The contact sensor 214 is not limited to the infrared blocking method, and may employ a different type of detecting device, such as a capacitance touch panel that identifies the contact position by detecting a change in capacitance, a resistive touch panel that identifies the contact position by detecting a change in voltage of two resistance films facing each other, or an electromagnetic induction touch panel that identifies the contact position by detecting electromagnetic induction caused by contact of an object on a display. Further, the electronic pen controller 216 may determine contact or non-contact of a part of the electronic pen 2500 held by the user or another part of the electronic pen 2500, as well as the head or end of the electronic pen 2500.

With the hardware configuration illustrated in FIG. 3, the electronic whiteboard 200 of the first embodiment is capable of executing a variety of processes described later. The smart speaker 2200 of the first embodiment is an example of the sound collecting device. The smart speaker 2200 has a microphone and a function of connecting to a network, for example. Further, the smart speaker 2200 of the first embodiment is equipped with artificial intelligence, for example, and performs communication in conformity with a standard such as wireless-fidelity (Wi-Fi) or Bluetooth to collect and reproduce audio data or to serve various other purposes.

In the first embodiment, a command to the electronic whiteboard 200 may be acquired from the audio data collected by the smart speaker 2200, for example. Further, although the smart speaker 2200 is used as the sound collecting device in the example of FIG. 3, the sound collecting device is not limited to the smart speaker 2200. The electronic whiteboard 200 may include an ordinary microphone in place of the smart speaker 2200.

Further, the electronic whiteboard 200 may be wirelessly connected to the smart speaker 2200 by the wireless LAN module 207 and the network connecting function of the smart speaker 2200.

A hardware configuration of the smart speaker 2200 of the first embodiment will be described below.

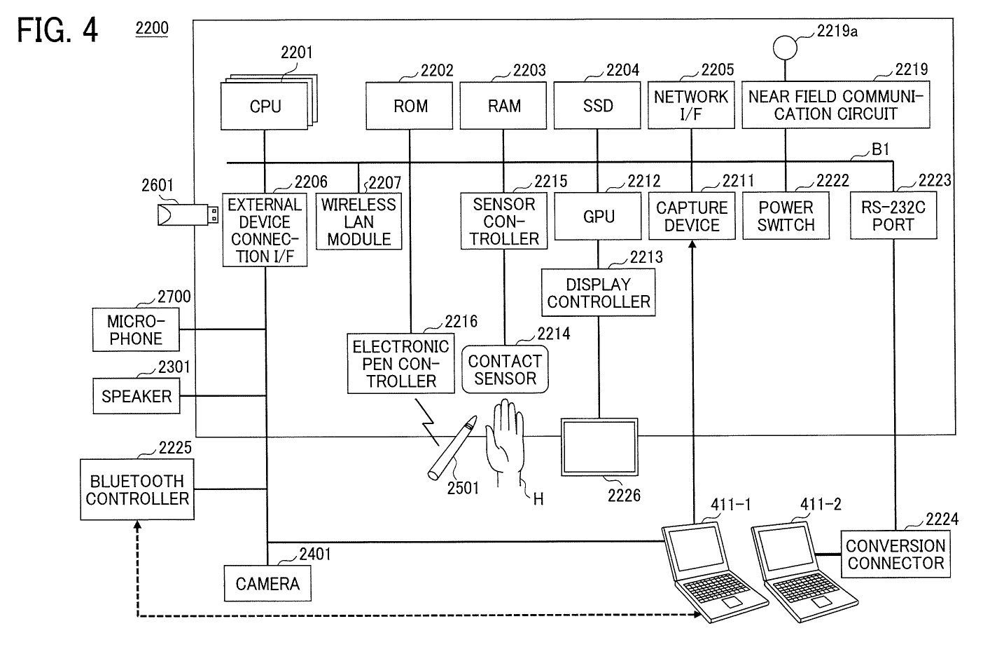

FIG. 4 is a diagram illustrating an example of the hardware configuration of the smart speaker 2200 of the first embodiment. The smart speaker 2200 is an information terminal including a CPU 2201, a ROM 2202, a RAM 2203, an SSD 2204, a network I/F 2205, an external device connection I/F 2206, and a wireless LAN module 2207.

The CPU 2201 controls an overall operation of the smart speaker 2200. The CPU 2201 may include a plurality of CPUs, for example.

The ROM 2202 stores a program used to drive the CPU 2201, such as the IPL. The RAM 2203 is used as a work area for the CPU 2201. The SSD 2204 stores a variety of data such as programs for the smart speaker 2200. The network I/F 2205 controls communication with a communication network. The external device connection IN 2206 controls communication with a USB memory 2601 and external devices such as a camera 2401, a speaker 2301, and a microphone 2700. The wireless LAN module 2207 connects the smart speaker 2200 to a network via a wireless LAN.

The smart speaker 2200 further includes a capture device 2211, a GPU 2212, a display controller 2213, a contact sensor 2214, a sensor controller 2215, an electronic pen controller 2216, a near field communication circuit 2219 including an antenna 2219a, and a power switch 2222.

The capture device 2211 displays visual information on a display of a PC 411-1 as a still or video image. The GPU 2212 is a semiconductor chip specifically for graphics processing. The display controller 2213 controls and manages screen display to output an input image from the GPU 2212 to a display 2226, for example. The contact sensor 2214 detects contact of an electronic pen 2501 or the hand H of the user on the display 2226.

The sensor controller 2215 controls the processing of the contact sensor 2214. The contact sensor 2214 performs input and detection of coordinates according to an infrared blocking method. In this method of inputting and detecting coordinates, two light receiving devices installed to opposite end portions of an upper area of the display 2226 radiate a plurality of infrared rays parallel to the display 2226, and receive rays of light reflected by a reflecting member installed around the display 2226 and returning on optical paths of the rays radiated by the two light receiving devices. The contact sensor 2214 outputs, to the sensor controller 2215, IDs of the infrared rays radiated by the two light receiving devices and blocked by an object. Then, the sensor controller 2215 identifies the position of the coordinates, which corresponds to the position of contact of the object on the display 2226.

The electronic pen controller 2216 communicates with the electronic pen 2501 to determine contact or non-contact of the head or end of the electronic pen 2501 on the display 2226. The near field communication circuit 2219 is a communication circuit using a technology such as NFC or Bluetooth.

The power switch 2222 is a switch for switching on or off a power supply of the smart speaker 2200.

The smart speaker 2200 further includes a bus line B1, which includes address buses and data buses to electrically connect the CPU 2201 and the other component elements illustrated in FIG. 4 to each other.

The smart speaker 2200 further includes an RS-232C port 2223, a conversion connector 2224, and a Bluetooth controller 2225.

The RS-232C port 2223 is connected to the bus line B1 to connect the CPU 2201 to a PC 411-2, for example. The conversion connector 2224 is a connector for connecting the smart speaker 2200 to a USB port of the PC 411-2. The Bluetooth controller 2225 is a controller for communicating with the PC 411-1, for example, by using Bluetooth technology.

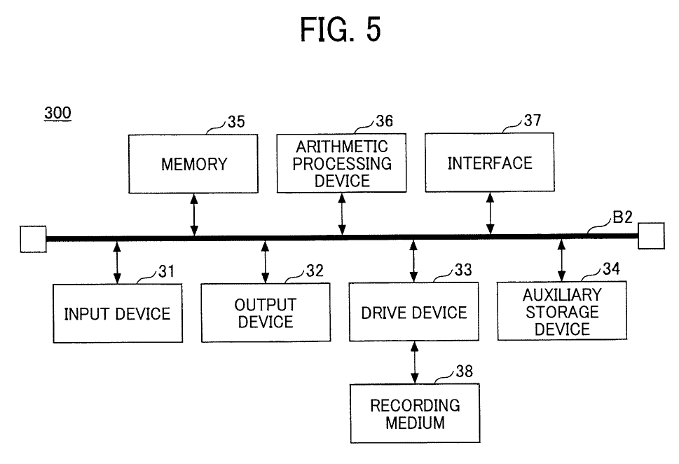

A hardware configuration of the server 300 of the first embodiment will now be described with FIG. 5.

FIG. 5 is a diagram illustrating an example of the hardware configuration of the server 300 of the first embodiment. The server 300 of the first embodiment is an information processing apparatus implemented by a typical computer, and serves as an external apparatus that communicates with the electronic whiteboard 200. The server 300 includes an input device 31, an output device 32, a drive device 33, an auxiliary storage device 34, a memory 35, an arithmetic processing device 36, and an interface 37, which are connected to each other by a bus B2.

The input device 31, which includes a mouse and a keyboard, for example, is used to input a variety of information. The output device 32, which is a display, for example, is used to display (i.e., output) a variety of signals. The interface 37, which includes a modem and a LAN card, for example, is used to connect the server 300 to a network.

The server 300 is provided with an information processing program as at least a part of a variety of programs for controlling the server 300. The information processing program is provided as distributed in a recording medium 38 or downloaded from the network, for example. Various types of recording media are usable as the recording medium 38 on which the information processing program is recorded. The various types of recording media include a recording medium on which information is optically, electrically, or magnetically recorded, such as a compact disc (CD)-ROM, a flexible disc, or a magneto-optical disc, and a semiconductor memory on which information is electrically recorded, such as a ROM or a flash memory.

When the recording medium 38 recorded with the information processing program is inserted in the drive device 33, the information processing program is installed into the auxiliary storage device 34 from the recording medium 38 via the drive device 33. Further, a communication program is downloaded from the network into the auxiliary storage device 34 via the interface 37.

The auxiliary storage device 34 stores the installed information processing program, and also stores files and data to be used. The memory 35 stores the information processing program read from the auxiliary storage device 34 at startup of the computer serving as the server 300. Then, the arithmetic processing device 36 executes a variety of later-described processes in accordance with programs stored in the memory 35.

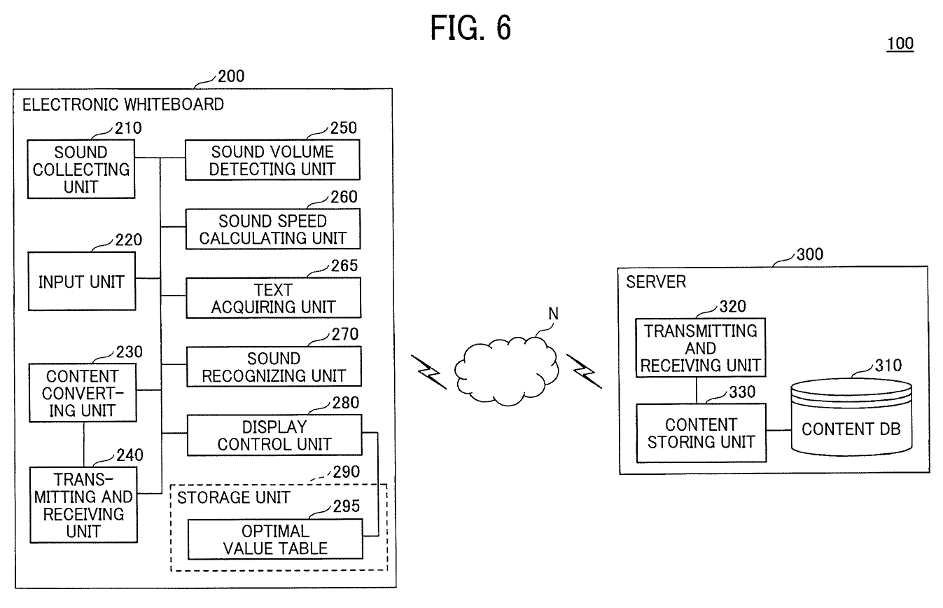

Functions of the electronic whiteboard 200 and the server 300 included in the information processing system 100 will now be described with FIG. 6.

FIG. 6 is a diagram illustrating functions of the electronic whiteboard 200 and the server 300 included in the information processing system 100 of the first embodiment.

Functions of the electronic whiteboard 200 will first be described.

The functions of the electronic whiteboard 200 described below are implemented when the CPU 201 reads and executes programs stored in a storage device such as the ROM 202.

The electronic whiteboard 200 of the first embodiment includes a sound collecting unit 210, an input unit 220, a content converting unit 230, a transmitting and receiving unit 240, a sound volume detecting unit 250, an sound speed calculating unit 260, a text acquiring unit 265, a sound recognizing unit 270, and a display control unit 280. The above-described units are implemented when the CPU 201 reads and executes the programs from a storage device such as the ROM 202.

The electronic whiteboard 200 of the first embodiment further includes a storage unit 290. The storage unit 290 stores an optimal value table 295. The storage unit 290 may be provided in a storage device such as the ROM 202 or the SSD 204 of the electronic whiteboard 200, for example.

The sound collecting unit 210 acquires the sounds input to the smart speaker 2200 as the audio data. The input unit 220 acquires the stoke information representing an input letter or image handwritten on the display 226 of the electronic whiteboard 200 and the image data of an image displayed on the display 226. In the first embodiment, the stroke information refers to information of the coordinates of dots representing the trajectory of each stroke handwritten on a touch panel by the user. The input unit 220 further acquires video data captured by the camera 2400.

The content converting unit 230 converts the audio data, the image data, and the video data into data in a format storable in the server 300. Specifically, the content converting unit 230 converts the audio data into advanced audio coding (AAC)-formatted data, and converts the image data or the video data into Joint Photographic Experts Group (JPEG)-formatted data, for example. In the first embodiment, the content converting unit 230 thus compresses a variety of data to facilitate transmission and reception of the data via the network N and prevent the data from consuming much of memory capacity of the server 300. In the first embodiment, the video data is included in the image data.

The transmitting and receiving unit 240 transmits the audio data acquired by the sound collecting unit 210 to the server 300 and the sound recognizing unit 270. In this process, the electronic whiteboard 200 may transmit the audio data to an external terminal not included in the information processing system 100. The external terminal may be a sound recognizing apparatus with a sound recognizing function, for example. The transmitting and receiving unit 240 further transmits the image data and video data acquired by the input unit 220 to the server 300.

The sound volume detecting unit 250 of the first embodiment detects the sound volume of the audio data acquired by the sound collecting unit 210. The sound speed calculating unit 260 of the first embodiment calculates the speaking speed of the speaker P when the audio data acquired by the sound collecting unit 210 includes speech data.

A description will be given below of the calculation of the speaking speed of the speaker P performed by the sound speed calculating unit 260.

The sound speed calculating unit 260 of the first embodiment may obtain the number of phonemes per unit time from the waveform of the audio data acquired by the sound collecting unit 210, and determine the obtained number of phonemes as the speaking speed. The phoneme is the minimum unit on the timeline in phonology. That is, the phoneme is the minimum sound unit functioning to distinguish the meanings of two words. Specifically, /a/and /i/, for example, are examples of phonemes. In the first embodiment, the unit time may previously be set.

As described above, the sound speed calculating unit 260 of the first embodiment functions as a sound speed calculating unit that obtains the number of phonemes per unit time from the audio data and determines the obtained number of phonemes as the speaking speed.

The text acquiring unit 265 acquires the text data generated based on the audio data acquired by the sound collecting unit 210. Specifically, when the sound collecting unit 210 acquires the audio data, the text acquiring unit 265 transmits the audio data to an external server having the sound recognizing function (i.e., a sound recognizing server) via the transmitting and receiving unit 240. The text acquiring unit 265 then acquires, via the transmitting and receiving unit 240, the text data converted from the audio data by the sound recognizing server. The sound recognizing server is also referred to as the sound recognizing apparatus. The sound recognizing apparatus of the first embodiment may be the server 300 or an apparatus different from the server 300, for example.

If the audio data is converted into the text data by the sound recognizing unit 270, the text acquiring unit 265 acquires the text data from the sound recognizing unit 270. The sound recognizing unit 270 implements the sound recognizing function of converting the audio data acquired by the sound collecting unit 210 into the text data.

The display control unit 280 refers to the optimal value table 295 stored in the storage unit 290, and displays, on the electronic whiteboard 200, the sound volume detected by the sound volume detecting unit 250 and the sound speed calculated by the sound speed calculating unit 260 together with the respective optimal values of the sound volume and the sound speed. Details of the optimal value table 295 will be described later.

Functions of the server 300 will now be described.

The server 300 of the first embodiment includes the content DB 310, a transmitting and receiving unit 320, and a content storing unit 330. These units of the server 300 of the first embodiment are implemented when the arithmetic processing device 36 reads and executes the information processing program from the memory 35.

The content DB 310 of the first embodiment may be provided in the auxiliary storage device 34 of the server 300, for example. The content DB 310 stores a variety of data (i.e., content) received from the electronic whiteboard 200. The content of the first embodiment includes the audio data, the image data, the video data, and the stroke information.

The transmitting and receiving unit 320 of the first embodiment transmits and receives information to and from the electronic whiteboard 200, and receives information from the sound recognizing unit 270.

The content storing unit 330 stores the content received from the electronic whiteboard 200 into the content DB 310.

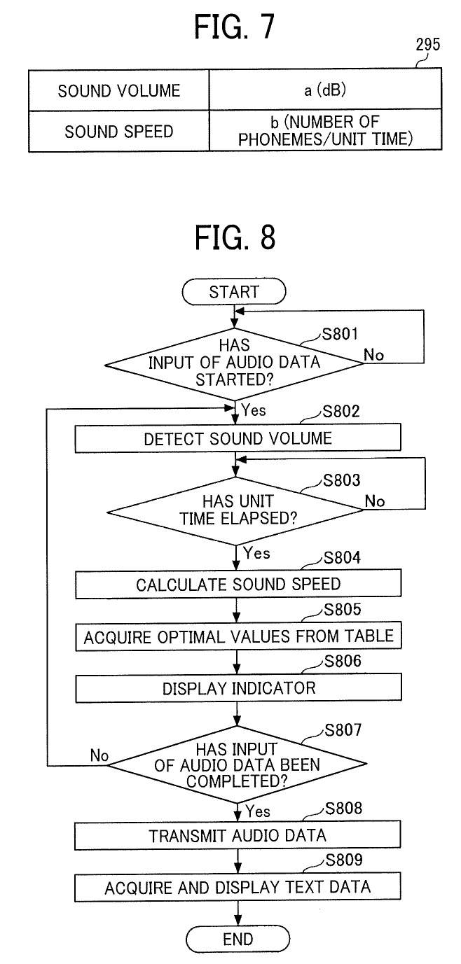

The optimal value table 295 will now be described with FIG. 7.

FIG. 7 is a diagram illustrating the optimal value table 295 as an example of the optimal value table of the first embodiment. The optimal value table 295 of the first embodiment includes the optimal value of the sound volume and the optimal value of the speaking speed of the speaker P. In FIG. 7, each of reference signs a and b represents a numerical value.

The optimal value of the sound volume may be obtained by inputting audio data to the sound recognizing function at a variety of sound volumes, and identifying the sound volume that maximizes the degree of match between the audio data and the text data resulting from sound recognition, for example. The optimal value of the sound volume may previously be obtained by such a method and stored in the optimal value table 295.

The optimal value of the speaking speed may be obtained by inputting audio data of speech to the sound recognizing function at a variety of sound speeds, and identifying the speaking speed that maximizes the degree of match between the audio data and the text data resulting from sound recognition, for example. The optimal value of the speaking speed may previously be obtained by such a method and stored in the optimal value table 295. The unit time of the first embodiment may be a few seconds, for example.

An operation of the electronic whiteboard 200 of the first embodiment will now be described with FIG. 8.

FIG. 8 is a flowchart illustrating an operation of the electronic whiteboard 200 of the first embodiment. In the electronic whiteboard 200 of the first embodiment, the sound volume detecting unit 250 determines whether the input of the audio data has started (step S801). That is, the sound volume detecting unit 250 determines whether the sound collecting unit 210 has started acquiring the audio data.

If the input of the audio data has not started at step S801 (No at step S801), the sound volume detecting unit 250 stands by until the input of the audio data starts.

If the input of the audio data has started at step S801 (Yes at step S801), the sound volume detecting unit 250 detects the sound volume of the audio data (step S802). Then, in the electronic whiteboard 200, the sound speed calculating unit 260 determines whether the unit time has elapsed (step S803).

If the unit time has not elapsed at step S803 (No at step S803), the sound speed calculating unit 260 stands by until the unit time elapses.

If the unit time has elapsed at step S803 (Yes at step S803), the sound speed calculating unit 260 calculates the sound speed (i.e., speaking speed) per unit time (step S804).

Then, based on the sound volume detected by the sound volume detecting unit 250 and the sound speed calculated by the sound speed calculating unit 260, the display control unit 280 acquires the optimal value of the sound volume and the optimal value of the sound speed by referring to the optimal value table 295 (step S805).

The display control unit 280 then displays, on the electronic whiteboard 200, the indicator 21 illustrated in FIG. 1, which associates the sound volume detected by the sound volume detecting unit 250 and the sound speed calculated by the sound speed calculating unit 260 with the optimal value of the sound volume and the optimal value of the sound speed, respectively (step S806).

Then, the electronic whiteboard 200 determines whether the input of the audio data has been completed (step S807). That is, the electronic whiteboard 200 determines whether the sound collecting unit 210 has stopped acquiring the audio data.

If the input of the audio data has not been completed, i.e., if the input of the audio data has been continuing at step S807 (No at step S807), the electronic whiteboard 200 returns to step S802.

If the input of the audio data has been completed at step S807 (Yes at step S807), the text acquiring unit 265 of the electronic whiteboard 200 transmits the input audio data to the sound recognizing server (step S808). The text acquiring unit 265 then acquires the text data from the sound recognizing server, and the display control unit 280 displays the text data together with the indicator 21 (step S809). Thereby, the operation of the electronic whiteboard 200 is completed.

In the example of FIG. 8, the audio data is transmitted to the sound recognizing server after the input of the audio data is completed. The transmission of the audio data, however, is not limited thereto. In the first embodiment, the audio data may be transmitted to the sound recognizing server at a desired time after the start of the input of the audio data before the completion of the input of the audio data.

Further, in the first embodiment, which of the external sound recognizing server and the sound recognizing unit 270 is to perform the process of converting the input audio data into the text data may be set in the electronic whiteboard 200. In this case, the text acquiring unit 265 may acquire the text data based on the setting.

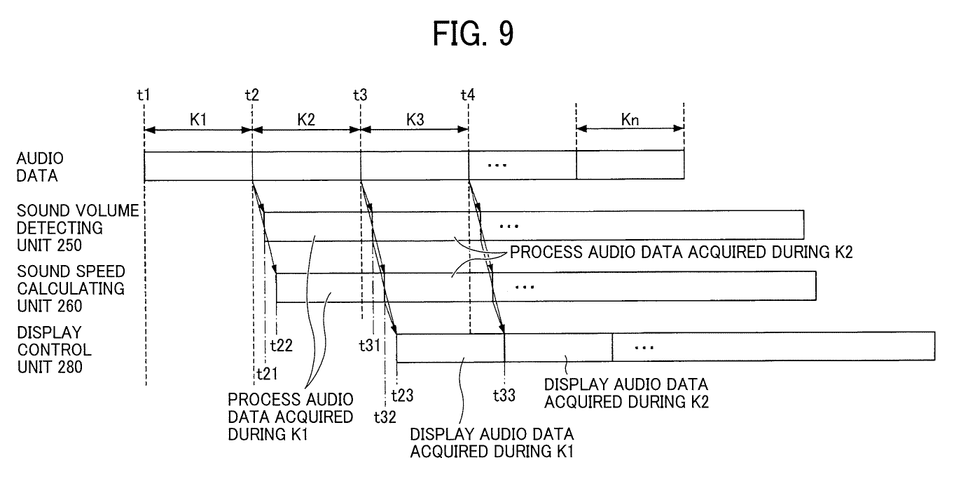

The operation illustrated in FIG. 8 will be described in more detail below with FIG. 9.

FIG. 9 is a diagram illustrating processes performed by the electronic whiteboard 200 of the first embodiment. FIG. 9 illustrates an example of respective times at which the sound volume detecting unit 250, the sound speed calculating unit 260, and the display control unit 280 start processing thereof when the sound collecting unit 210 starts acquiring the audio data at a time t1.

When the input of the audio data starts at the time t1, the sound collecting unit 210 acquires the audio data during a period K1 from the time t1 to a time t2, for example. Then, at a time t21 immediately after the acquisition of the audio data during the period K1 at the time t2, the sound volume detecting unit 250 starts a process of detecting the sound volume of the audio data acquired by the sound collecting unit 210 during the period K1, to thereby detect the sound volume.

At a time t22 immediately after the sound volume detecting unit 250 starts the process of detecting the sound volume of the audio data acquired during the period K1, the sound speed calculating unit 260 starts a process of calculating the sound speed of the audio data acquired during the period K1.

At a time t23 at which the detection of the sound volume and the calculation of the sound speed of the audio data acquired during the period K1 are completed, the display control unit 280 displays the detected sound volume and the calculated sound speed on the electronic whiteboard 200 together with the respective optimal values of the sound volume and the sound speed.

At a time t31 immediately after a time t3, the sound volume detecting unit 250 starts a process of detecting the sound volume of the audio data acquired during a period K2 from the time t2 to the time t3.

At a time t32 immediately after the sound volume detecting unit 250 starts the process of detecting the sound volume of the audio data acquired during the period K2, the sound speed calculating unit 260 starts a process of calculating the sound speed of the audio data acquired during the period K2.

At a time t33 at which the detection of the sound volume and the calculation of the sound speed of the audio data acquired during the period K2 are completed, the display control unit 280 displays the detected sound volume and the calculated sound speed on the electronic whiteboard 200 together with the respective optimal values of the sound volume and the sound speed.

As described above, during the input of the audio data in the first embodiment, the detection of the sound volume and the calculation of the sound speed of the audio data continue, making it possible to display the indicator 21 in accordance with the speech of the speaker P.

In the example of FIG. 9, each of periods K1 to Kn may correspond to the unit time used to calculate the sound speed.

Further, the detection of the sound volume by the sound volume detecting unit 250 and the calculation of the sound speed by the sound speed calculating unit 260 are a sequential process in the examples of FIGS. 8 and 9, but are not limited thereto. The detection of the sound volume by the sound volume detecting unit 250 and the calculation of the sound speed by the sound speed calculating unit 260 may be executed as mutually independent processes.

In this case, the display control unit 280 may acquire the sound volume and the sound speed from the sound volume detecting unit 250 and the sound speed calculating unit 260 respectively and separately, and may display the indicator 21 together with the optimal values acquired from the optimal value table 295.

Further, in the first embodiment, when the audio data is input, the sound volume, the sound speed, and the respective optimal values of the sound volume and the sound speed are displayed as the indicator 21. However, the display of information is not limited thereto.

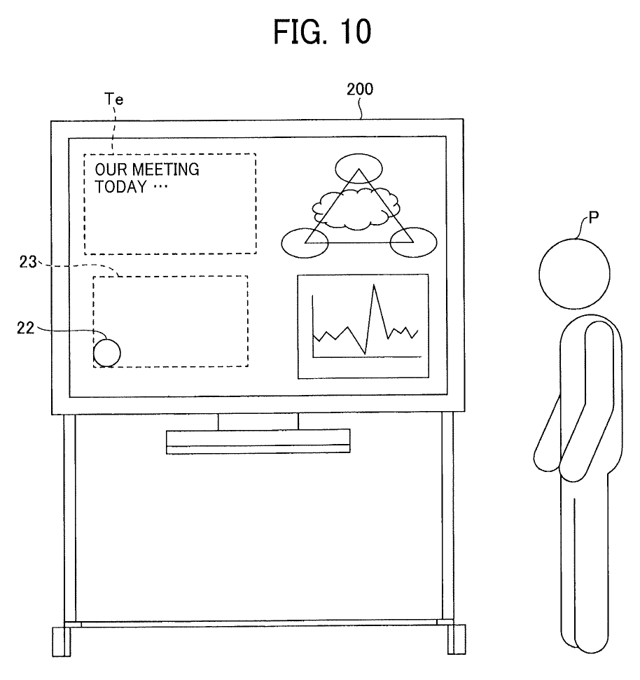

FIG. 10 is a diagram illustrating another example of display of the electronic whiteboard 200 of the first embodiment. In the example of FIG. 10, the indicator 21 is replaced by an icon 22, which is displayed to display the indicator 21.

In the example of FIG. 10, when an operation of selecting the icon 22 is performed, the display control unit 280 may display the indicator 21 in FIG. 1 in an area 23 near the icon 22. Further, in this case, if the operation of selecting the icon 22 is performed again when the indicator 21 is displayed, the display control unit 280 may hide the display of the indicator 21.

That is, the electronic whiteboard 200 of the first embodiment is capable of switching between display and non-display of the indicator 21 including the sound volume and the sound speed of the audio data and the respective optimal values thereof. According to the first embodiment, therefore, it is possible to display the indicator 21 to the speaker P at a desired time to present the sound volume and the sound speed of the speech of the speaker P and the respective optimal values thereof, and thus to improve the accuracy of conversion from the audio data into the text data.

The display of the indicator 21 is not limited to the example illustrated in FIG. 1. In the indicator 21, each of the sound volume, the optimal value thereof, the sound speed, and the optimal value thereof may be displayed as a numerical value. The indicator 21 may be displayed in any display mode, as long as the indicator 21 presents a result of comparing the sound volume detected by the sound volume detecting unit 250 with the optimal value of the sound volume and a result of comparing the sound speed calculated by the sound speed calculating unit 260 with the optimal value of the sound speed.

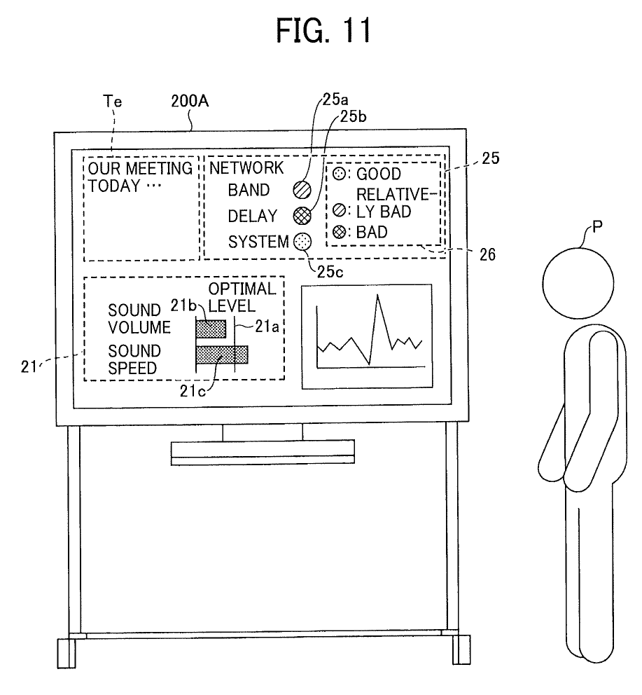

A second embodiment of the present invention will be described below with FIGS. 11 to 15.

The second embodiment is different from the first embodiment in displaying an indicator of the status of communication between an electronic whiteboard and an external apparatus. The following description of the second embodiment will focus on differences from the first embodiment. Component elements of the second embodiment similar in functional configuration to those of the first embodiment will be denoted with the same reference numerals as those used in the first embodiment, and description thereof will be omitted.

FIG. 11 is a diagram illustrating an example of display of an electronic whiteboard of the second embodiment. An electronic whiteboard 200A of the second embodiment displays the indicator 21 and an indicator 25.

The indicator 25 includes information of the status of communication between the electronic whiteboard 200A and the external apparatus and information of the status of the electronic whiteboard 200A.

The information of the status of communication includes the status of the band of the network N connecting the electronic whiteboard 200A and the server 300 and the status of delay in communication between the electronic whiteboard 200A and the server 300, for example. In the following description, the time taken for communication will be referred to as the communication delay time. In the second embodiment, an increase in the communication delay time degrades the status of delay in communication, and a reduction in the communication delay time improves the status of delay in communication.

The information of the status of the electronic whiteboard 200A is represented by the CPU utilization and the memory utilization of the electronic whiteboard 200A, for example.

As the indicator 25 of the second embodiment, icons 25a, 25b, and 25c are displayed. The icon 25a represents the status of the band of the network N. The icon 25b represents the status of delay in communication. The icon 25c represents the status of the electronic whiteboard 200A. Each of the icons 25a, 25b, and 25c changes in color depending on the status corresponding to the icon.

In the second embodiment, each of the icons 25a, 25b, and 25c thus changes in color depending on the corresponding status, thereby presenting the current status of communication and the current status of the electronic whiteboard 200A to the speaker P.

The indicator 25 further includes information 26 that associates colors of the icons 25a, 25b, and 25c with statuses represented by the colors. In the information 26, three colors are associated with three statuses: GOOD, RELATIVELY BAD, and BAD.

In the second embodiment, the indicator 25 displays the information 26 together with the icons 25a, 25b, and 25c, thereby facilitating the speaker P and a user of the electronic whiteboard 200A to understand the status of communication and the status of the electronic whiteboard 200A.

Each of the information of the status of communication and the information of the status of the electronic whiteboard 200A is not necessarily displayed as an icon, and may be displayed in text, such as GOOD, RELATIVELY BAD, or BAD, for example.

Further, in the example of FIG. 11, the indicator 25 is displayed at a position diagonal to the indicator 21 on a display of the electronic whiteboard 200A. However, the display position of the indicator 25 is not limited thereto, and may be a desired position. The display position of the indicator 25 may be set by the speaker P or the user of the electronic whiteboard 200A.

Further, in the example of FIG. 11, the indicator 25 includes the information of the status of the electronic whiteboard 200A. However, the indicator 25 is not limited to this example. The indicator 25 may only include the information of the status of communication between the electronic whiteboard 200A and the external apparatus. Specifically, all icons included in the indicator 25 may be the icons 25a and 25b.

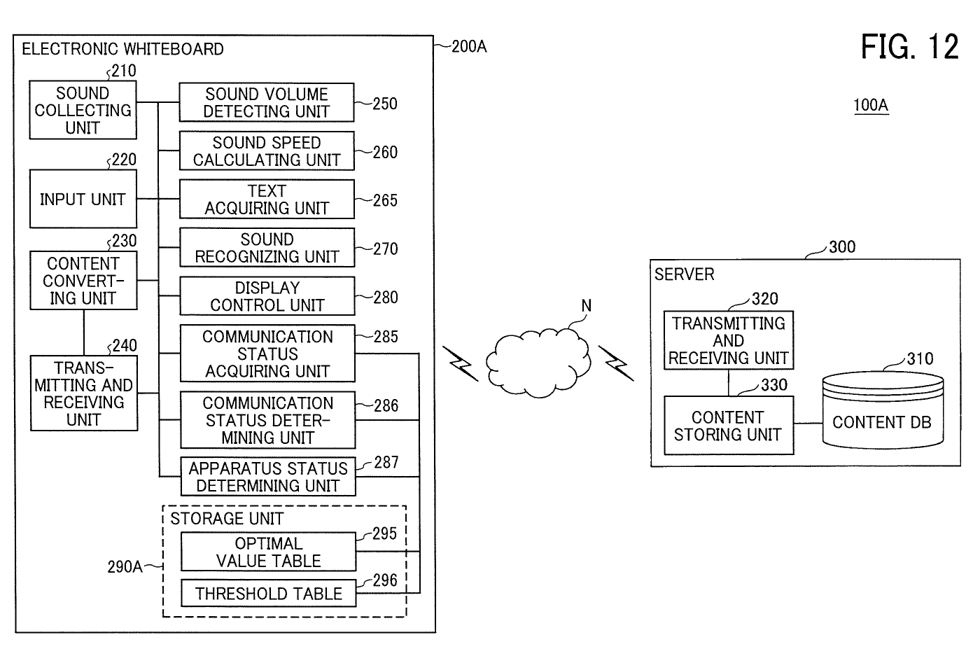

Functions of the electronic whiteboard 200A and the server 300 included in an information processing system 100A of the second embodiment will now be described with FIG. 12.

FIG. 12 is a diagram illustrating functions of the electronic whiteboard 200A and the server 300 included in the information processing system 100A of the second embodiment. The electronic whiteboard 200A of the second embodiment includes the sound collecting unit 210, the input unit 220, the content converting unit 230, the transmitting and receiving unit 240, the sound volume detecting unit 250, the sound speed calculating unit 260, the text acquiring unit 265, the sound recognizing unit 270, the display control unit 280, a communication status acquiring unit 285, a communication status determining unit 286, and an apparatus status determining unit 287.

The electronic whiteboard 200A of the second embodiment further includes a storage unit 290A. The storage unit 290A stores the optimal value table 295 and a threshold table 296.

The communication status acquiring unit 285 of the second embodiment acquires the communication delay time and the band of the network N used in the communication between the electronic whiteboard 200A and the external apparatus (i.e., the server 300 in this example).

Specifically, the communication status acquiring unit 285 determines the communication delay time as the time from a transmission time at which data is transmitted from the electronic whiteboard 200A to the server 300 to a reception time at which a response to the transmitted data is received. Alternatively, the communication status acquiring unit 285 of the second embodiment may measure the time from the transmission of data from the electronic whiteboard 200A to an apparatus other than the server 300 to the receipt of a response to the transmitted data, and may determine the measured time as the communication delay time.

The communication status acquiring unit 285 further acquires, as the band of the network N, the amount of data transmitted during the period from the transmission time to the reception time. In the second embodiment, the band of the network N refers to the transmission line capacity, i.e., bit rate or bits per second (bps), of the network N. That is, the band of the network N represents the data transmission capacity of the network N, i.e., the amount of data that the network N is capable of transmitting per unit time.

Based on the communication delay time or the band of the network N acquired by the communication status acquiring unit 285, the communication status determining unit 286 of the second embodiment determines the status of communication between the electronic whiteboard 200A and the external apparatus (i.e., the server 300) by referring to the threshold table 296.

As described above, the communication status determining unit 286 of the second embodiment determines the status of communication based on the threshold table 296 and one of the communication delay time and the band of the network N. However, the determination of the communication status determining unit 286 is not limited thereto. The communication status determining unit 286 may determine the status of communication based on the threshold table 296 and both of the communication delay time and the band of the network N. Details of the threshold table 296 will be described later.

The apparatus status determining unit 287 of the second embodiment acquires the CPU utilization and the memory utilization of the electronic whiteboard 200A, and determines the status of the electronic whiteboard 200A by referring to the threshold table 296. The status of the electronic whiteboard 200A corresponds to the magnitude of the processing load on the electronic whiteboard 200A.

The CPU utilization acquired by the apparatus status determining unit 287 may be the CPU utilization values of all CPUs included in the electronic whiteboard 200A, the mean of the CPU utilization values of all of the CPUs, or the CPU utilization value of a specific one of the CPUs, for example. Further, the memory utilization acquired by the apparatus status determining unit 287 may be the memory utilization values of all memories included in the electronic whiteboard 200A, the mean of the memory utilization values of all of the memories, or the memory utilization value of a specific one of the memories, for example. In the following description, the CPU utilization and the memory utilization will be collectively described as the apparatus information.

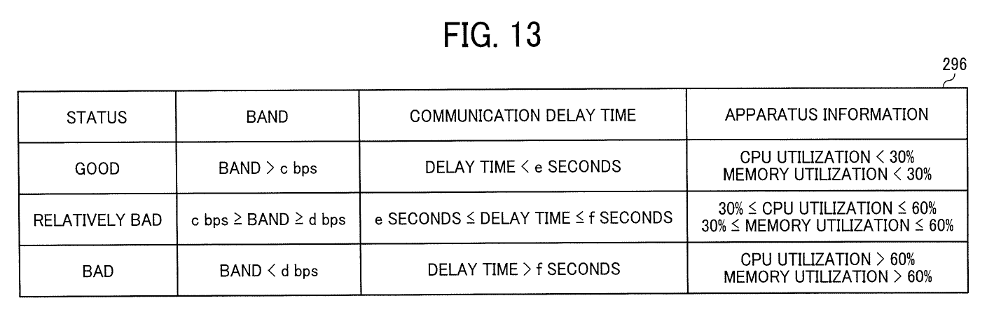

The threshold table 296 of the second embodiment will now be described with FIG. 13.

FIG. 13 is a diagram illustrating an example of the threshold table 296 of the second embodiment. The threshold table 296 of the second embodiment includes STATUS, BAND, COMMUNICATION DELAY TIME, and APPARATUS INFORMATION as information items. In the threshold table 296, the item STATUS and the other items BAND, COMMUNICATION DELAY TIME, and APPARATUS INFORMATION are associated with each other. In FIG. 13, each of reference signs c to f represents a numerical value.

The value of the item STATUS represents the status of communication between the electronic whiteboard 200A and the external apparatus or the status of the electronic whiteboard 200A. Specifically, GOOD, RELATIVELY BAD, and BAD are examples of the value of the item STATUS.

The value of the item BAND represents the band acquired by the communication status acquiring unit 285. The value of the item COMMUNICATION DELAY TIME represents the communication delay time acquired by the communication status acquiring unit 285. The value of the item APPARATUS INFORMATION represents the CPU utilization and the memory utilization of the electronic whiteboard 200A acquired by the apparatus status determining unit 287.

With reference to the optimal value table 295, the communication status determining unit 286 of the second embodiment is capable of determining which of GOOD, RELATIVELY BAD, and BAD corresponds to the status of communication between the electronic whiteboard 200A and the external apparatus or the status of the electronic whiteboard 200A.

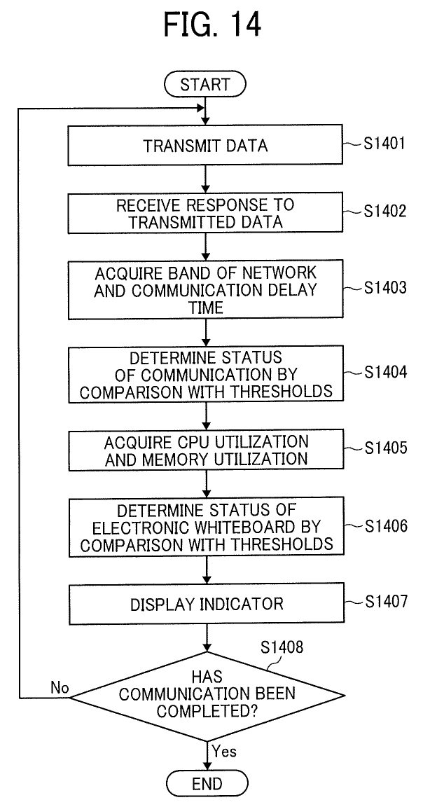

An operation of the electronic whiteboard 200A of the second embodiment will now be described with FIG. 14. An operation of displaying the indicator 21 according to the second embodiment is similar to that according to the first embodiment, and thus description thereof will be omitted.

FIG. 14 is a flowchart illustrating an operation of the electronic whiteboard 200A of the second embodiment. FIG. 14 illustrates a process of displaying the indicator 25.

In the electronic whiteboard 200A of the second embodiment, the communication status acquiring unit 285 transmits data to the external apparatus (step S1401), and receives a response to the transmitted data (step S1402). Then, in the electronic whiteboard 200A, the communication status acquiring unit 285 acquires the band of the network and the communication delay time from the transmission time of the data, the reception time of the response to the transmitted data, and the amount of the transmitted data (step S1403).

Then, with reference to the threshold table 296, the communication status determining unit 286 determines the status corresponding to the band of the network and the status corresponding to the communication delay time (step S1404).

Specifically, for example, if the value of the band acquired at step S1403 is included in the range corresponding to the status GOOD in the threshold table 296, the communication status determining unit 286 determines the status of the band as GOOD. Further, for example, if the communication delay time acquired at step S1403 is included in the range corresponding to the status RELATIVELY BAD in the threshold table 296, the communication status determining unit 286 determines the status of delay in communication as RELATIVELY BAD.

Then, in the electronic whiteboard 200A, the apparatus status determining unit 287 acquires the CPU utilization and the memory utilization of the electronic whiteboard 200A (step S1405). That is, the apparatus status determining unit 287 acquires the apparatus information of the electronic whiteboard 200A.

Then, with reference to the threshold table 296, the apparatus status determining unit 287 determines the status of the electronic whiteboard 200A (step S1406).

Specifically, for example, if the apparatus information (i.e., the CPU utilization and the memory utilization) acquired at step S1405 is included in the range corresponding to the status GOOD in the threshold table 296, the apparatus status determining unit 287 determines the status of the electronic whiteboard 200A as GOOD.

Then, in the electronic whiteboard 200A, the display control unit 280 displays the indicator 25 in accordance with the results of determination of the communication status determining unit 286 and the apparatus status determining unit 287 (step S1407).

The electronic whiteboard 200A then determines whether the communication with the external apparatus has been completed (step S1408). If the communication with the external apparatus has not been completed at step S1408 (No at step S1408), the electronic whiteboard 200A returns to step S1401. If the communication with the external apparatus has been completed at step S1408 (Yes at step S1408), the electronic whiteboard 200A completes the process.

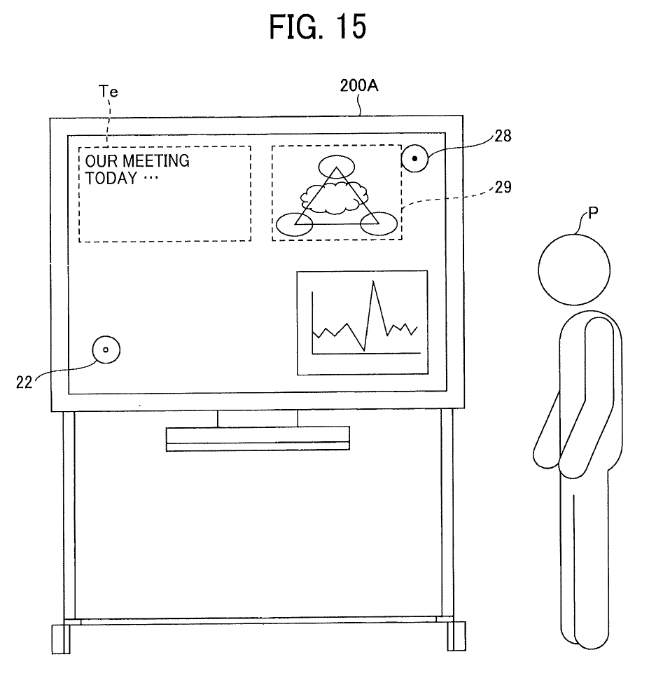

According to the second embodiment, it is possible to hide the display of the indicator 25 similarly to hiding of the display of the indicator 21. FIG. 15 is a diagram illustrating another example of display of the electronic whiteboard 200A of the second embodiment. In this display example of the electronic whiteboard 200A of the second embodiment, the display of the indicators 21 and 25 is hidden, and the icon 22 and an icon 28 are displayed instead.

When an operation of selecting the icon 28 is performed in the state illustrated in FIG. 15, the indicator 25 may be displayed in an area 29 near the icon 28.

As described above, in the second embodiment, it is possible to switch between display and non-display of the indicator 25. According to the second embodiment, therefore, when transmitting the audio data to the external sound recognizing apparatus to perform sound recognition on the audio data, for example, it is possible to present the status of communication with the external apparatus to the speaker P and the user of the electronic whiteboard 200A.

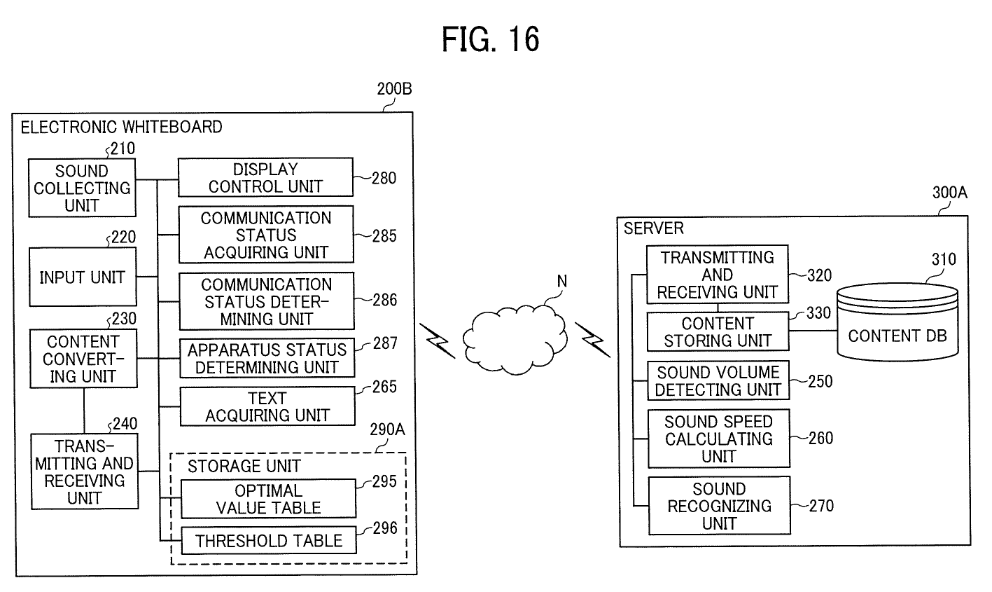

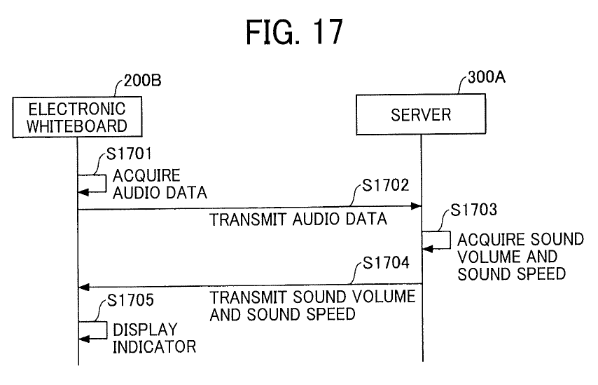

A third embodiment of the present invention will be described below with FIGS. 16 and 17.

The third embodiment is different from the first embodiment in that the detection of the sound volume and the calculation of the sound speed are performed by a server. The following description of the third embodiment will focus on differences from the first embodiment. Component elements of the third embodiment similar in functional configuration to those of the first embodiment will be denoted with the same reference numerals as those used in the first embodiment, and description thereof will be omitted.

FIG. 16 is a diagram illustrating functions of an electronic whiteboard and a server included in an information processing system of the third embodiment. An information processing system 100B of the third embodiment includes an electronic whiteboard 200B and a server 300A.

The electronic whiteboard 200B of the third embodiment includes the sound collecting unit 210, the input unit 220, the content converting unit 230, the transmitting and receiving unit 240, the display control unit 280, the communication status acquiring unit 285, the communication status determining unit 286, the apparatus status determining unit 287, the text acquiring unit 265, and the storage unit 290A.

The server 300A of the third embodiment includes the content DB 310, the transmitting and receiving unit 320, the content storing unit 330, the sound volume detecting unit 250, the sound speed calculating unit 260, and the sound recognizing unit 270.

An operation of the information processing system 100B of the third embodiment will be described below with FIG. 17.

FIG. 17 is a sequence diagram illustrating an operation of the information processing system 100B of the third embodiment. In the electronic whiteboard 200B of the information processing system 100B, the sound collecting unit 210 acquires the audio data (step S1701), and the transmitting and receiving unit 240 transmits the acquired audio data to the server 300A (step S1702).

In the server 300A, in response to receipt of the audio data, the sound volume detecting unit 250 detects the sound volume of the audio data, and the sound speed calculating unit 260 calculates the sound speed of the audio data (step S1703). The process of step S1703 in the server 300A is similar to the processes of steps S801 to S804 in FIG. 8, and thus description thereof will be omitted.

Then, in the server 300A, the transmitting and receiving unit 320 transmits the sound volume and the sound speed of the audio data to the electronic whiteboard 200B (step S1704).

In the electronic whiteboard 200B, in response to receipt of the sound volume and the sound speed of the audio data, the display control unit 280 displays the indicator 21 by referring to the optimal value table 295 (step S1705).

As described above, according to the third embodiment, the server 300A performs the detection of the sound volume and the calculation of the sound speed of the audio data, thereby reducing the processing load on the electronic whiteboard 200B.

In the example of FIG. 17, the server 300A includes the sound recognizing unit 270, and thus may perform the sound recognition. Alternatively, the sound recognizing unit 270 may be included in the electronic whiteboard 200B.

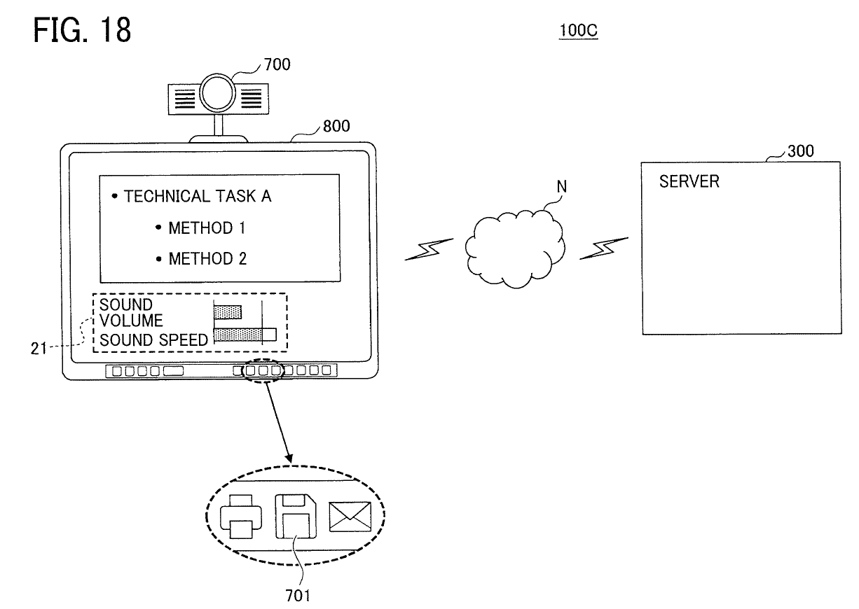

A fourth embodiment of the present invention will be described below with FIG. 18.

The fourth embodiment is different from the first embodiment in that an information processing system includes an image projecting apparatus in place of the electronic whiteboard. The following description of the fourth embodiment will focus on differences from the first embodiment. Component elements of the fourth embodiment similar in functional configuration to those of the first embodiment will be denoted with the same reference numerals as those used in the first embodiment, and description thereof will be omitted.

FIG. 18 is a diagram illustrating an information processing system of the fourth embodiment. An information processing system 100C illustrated in FIG. 18 includes an image projecting apparatus (i.e., projector) 700 and the server 300.

The image projecting apparatus 700 projects, on a screen 800, image data input from a terminal apparatus connected to the image projecting apparatus 700, for example. The screen 800 may be replaced by a whiteboard or a wall surface, for example. The screen 800 corresponds to the display 226 in FIG. 3.

The image projecting apparatus 700 further detects the motion of an electronic pen or a hand of a user, for example, to detect handwritten input to the screen 800, and projects a stroke image on the screen 800.

Similarly as in the first to third embodiments, in the fourth embodiment, the image projecting apparatus 700 includes a sound collecting device. In response to input of the audio data, the image projecting apparatus 700 acquires the sound volume and the sound speed of the audio data, and projects the indicator 21 on the screen 800.

Further, when a save button 701 is operated, for example, the image projecting apparatus 700 may transmit the image data and the audio data to the server 300 and also output the image data and the audio data to a portable recording medium, such as a USB memory, for example, to store the image data and the audio data therein.

As described above, according to the fourth embodiment, the information processing system 100C including the image projecting apparatus 700 and the server 300 is capable of presenting the indicator 21 to the speaker P to improve the accuracy of sound recognition, similarly as in the first to third embodiments.

Each of the information processing systems 100 to 100C of the foregoing embodiments may include a plurality of servers 300 or 300A, and the above-described functions may be provided to any of the plurality of servers 300 or 300A. Further, the above-described system configurations of the foregoing embodiments each connecting the shared terminal (i.e., the electronic whiteboard 200, 200A, or 200B or the image projecting apparatus 700) and the server 300 or 300A are illustrative, and various other system configuration examples are possible depending on purposes or uses.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. A shared terminal comprising processing circuitry, the processing circuitry being configured to:
acquire sound collected by a sound collecting device as audio data;
display a first indicator on a display, the first indicator including information of volume of the sound generated based on the audio data and information of speed of the sound calculated based on the audio data;
acquire text data generated based on the audio data; and
display the text data on the display together with the first indicator.

2. The shared terminal of claim 1, wherein the processing circuitry
transmits the audio data to a sound recognizing server, the sound recognizing server being communicable with the shared terminal via a network, and
acquires the text data from the sound recognizing server via the network as a response to the transmitted audio data.

3. The shared terminal of claim 2, wherein the processing circuitry
obtains a number of phonemes per unit time from the audio data and determines the obtained number as the speed of the sound, and
converts the audio data into the text data.

4. The shared terminal of claim 1, wherein the processing circuitry
acquires band information and a communication delay time, the band information representing a band of a network used in communication between the shared terminal and an external apparatus, and the communication delay time representing a time taken for communication between the shared terminal and the external apparatus,
determines a communication status of communication between the shared terminal and the external apparatus based on the acquired band information or communication delay time, and
displays the determined communication status on the display as a second indicator representing the communication status of communication between the shared terminal and the external apparatus.

5. The shared terminal of claim 4, further comprising a memory configured to store a threshold table that associates the communication status with a first threshold value set for the band information and a second threshold value set for the communication delay time,
wherein the processing circuitry determines the communication status with reference to the threshold table.

6. The shared terminal of claim 5, wherein the threshold table further associates a status of the shared terminal with a third threshold value set for a utilization of at least one arithmetic processing device of the shared terminal and a fourth threshold value set for a utilization of at least one memory of the shared terminal, and
wherein the processing circuitry
acquires the utilization of the at least one arithmetic processing device of the shared terminal and the utilization of the at least one memory of the shared terminal,
determines the status of the shared terminal with reference to the threshold table, and
includes the determined status of the shared terminal in the second indicator representing the communication status.

7. An information processing system comprising:
a shared terminal;
an information processing apparatus configured to communicate with the shared terminal; and
processing circuitry configured to
acquire sound collected by a sound collecting device as audio data,
display a first indicator on a display, the first indicator including information of volume of the sound generated based on the audio data and information of speed of the sound calculated based on the audio data,
acquire text data generated based on the audio data, and
display the text data on the display together with the first indicator.

8. A display controlling method comprising:
acquiring sound collected by a sound collecting device as audio data;
displaying a first indicator on a display, the first indicator including information of volume of the sound generated based on the audio data and information of speed of the sound calculated based on the audio data;
acquiring text data generated based on the audio data; and
displaying the text data on the display together with the first indicator.
